(19) United States
(12) Patent Application Publication
(10) Pub. No.: US 2023/0115904 A1
(43) Pub. Date: Apr. 13, 2023

(54) A MODULAR ACCESSORY DEVICE FOR A TRANSMITTER DEVICE

(71) Applicant: SCHNEIDER ELECTRIC ASIA PTE LTD, Singapore (SG)

(72) Inventors: Mathew Adam WILLIAMS, Singapore (SG); Aurelien Albert Francois FRANC, Singapore (SG); Jordan XU, Singapore (SG); Caijin WANG, Singapore (SG); Andy KOH, Singapore (SG)

(21) Appl. No.: 17/800,805

(22) PCT Filed: Jun. 2, 2021
(86) PCT No.: PCT/SG2021/050315

§ 371 Date: Aug. 18, 2022

(51) Int. Cl. H01H 13/02; H04B 10/40; H01H 9/16

(52) U.S. Cl. CPC H01H 13/023; H01H 9/161; H04B 10/40; H01H 2207/00

(57) ABSTRACT

A modular accessory device and a transmitter device for coupling to the modular accessory device are provided. The modular accessory device comprises a first connector module for coupling to a first transmitter device, the first connector module comprising a first input member; a power source controller coupled to the first connector module, the power source controller further arranged to be coupled to a power source; a visual indicator member coupled to the first connector module; wherein the first input member is arranged to receive a signal from the first transmitter device to instruct a first provision of power from the power source to the first transmitter device and a second provision of power to the visual indicator member; and further wherein the visual indicator member is arranged to be activated based on an indicator control signal received from the first transmitter device via the first input member.

### TECHNICAL FIELD

The present disclosure relates broadly to a modular accessory device for coupling to a transmitter device.

### BACKGROUND

Technology has increasingly progressed to desiring the use of wireless and batteryless transmitter devices for communication of signals to receivers at devices / machineries.

For such a transmitter device to be used with an actuation device, for example a push button, a selector switch etc., without a self-contained sufficient power source in the transmitter device, such a transmitter device typically only may generate enough / sufficient power to transmit communication signals to a receiver when the actuation device is activated. The transmitter device then subsequently powers down due to the insufficient power.

One problem that may arise is that there is no ensuring that the receiver has received the communication signals from the transmitter device. Another problem that may arise is that there is also no indication to show that the receiver is ready to communicate with the transmitter device.

Another problem that may arise due to the use of such transmitter devices is that an operator, using the actuation device coupled to the wireless and batteryless transmitter device, may not be certain that the transmitter device is properly communicating with the receiver.

Currently, an indication to an operator may typically be achieved by directly wiring an actuation device, e.g. a pushbutton, to a device / machinery for control of the device / machinery. In this case, the indication to the operator is the result of the command on the device / machinery. For example, in the case of a pushbutton which turns on a machine, if the pushbutton is hard wired to the machine, the indication / confirmation that the pushbutton is properly communicating with the device / machinery is when the device / machinery starts operating. However, it is appreciated that such an approach requires wiring to be conducted between the pushbutton and the device / machinery which typically needs ample working space and time. Maintenance also needs to be done for such hard wiring which typically increases costs.

In parallel, it has also been recognized that a transmitter device of the current prior art with a form of visual indication may work only or may couple / mate with only a dedicated pushbutton. The pushbutton is manufactured with a one-to-one relationship with the transmitter device. This may lead to an increase in costs and complexity in logistics since customized pushbuttons have to be procured for different types or models of transmitters. Further, such transmitter devices do not work with other forms of actuation devices such as a selector switch. This leads to limitations in the applications or systems which may be used for such transmitter devices.

Further, for such transmitter devices, the visual indicators may be in-built / integrated with transmitter devices. Each such transmitter device has to have internally sufficient power source to power the visual indicator. The indicator cannot be separated from the transmitter device. Each indicator works for only one transmitter device. The above requirements may lead to a large form factor for such a transmitter device. Further, such an arrangement may cause a loss of performance for certain characteristics of the transmitter device due to technical compromises e.g. since power needs to be shared with the visual indicator. Moreover, there may be limited power available in the transmitter device for long term operation of the indicator in the transmitter device which may lead to a weak or unclear indication / feedback being shown to the operator or user.

Hence, in view of the above, there is a need for a modular accessory device for a transmitter device to address at least one of the above problems.

### SUMMARY

In accordance with an aspect of the present disclosure, there is provided a modular accessory device comprising, a first connector module for coupling to a first transmitter device, the first connector module comprising a first input member; a power source controller coupled to the first connector module, the power source controller further arranged to be coupled to a power source; a visual indicator member coupled to the first connector module; wherein the first input member is arranged to receive a signal from the first transmitter device to instruct a first provision of power from the power source to the first transmitter device and a second provision of power to the visual indicator member; and further wherein the visual indicator member is arranged to be activated based on an indicator control signal received from the first transmitter device via the first input member.

The visual indicator member may be disposed in the modular accessory device such that the visual indicator member is capable of being housed within an external actuation device.

The first connector module may be disposed on a first side wall of the modular accessory device.

The first connector module may further comprise a first output member for transmitting the first provision of power to the first transmitter device.

The modular accessory device may further comprise, a second connector module for coupling to a second transmitter device, the second connector module comprising a second input member; the second connector module being coupled to the power source controller and to the visual indicator member; wherein the second input member is arranged to receive a signal from the second transmitter device to instruct the first provision of power from the power source to the second transmitter device and the second provision of power to the visual indicator member; and further wherein the visual indicator member is arranged to be activated based on an indicator control signal received from the second transmitter device via the second input member.

The second connector module may be disposed on a second side wall of the modular accessory device.

The second connector module may further comprise a second output member for transmitting the first provision of power to the second transmitter device.

The modular accessory device may further comprise a mechanical transmitter mating member disposed on a housing of the modular accessory device wherein the mechanical transmitter mating member is adapted to mechanically couple to at least one transmitter device.

The modular accessory device may further comprise a mechanical actuator mating member disposed on a top surface of the modular accessory device wherein the mechanical actuator mating member is adapted to mechanically couple to at least one external actuator device.

In accordance with another aspect of the present disclosure, there is provided a transmitter device for coupling to the modular accessory device of the above aspect, the transmitter device comprising, at least one electrically conductive member disposed on at least one side wall of the transmitter device, the at least one electrically conductive member arranged to allow electrical coupling to the first connector module; a microcontroller module coupled to the at least one electrically conductive member; a transceiver mechanism coupled to the microcontroller module; wherein the microcontroller module is capable of transmitting a signal to the modular accessory device to instruct the first provision of power from the power source to the transmitter device; and further wherein the microcontroller module is capable of transmitting an indicator control signal to the modular accessory device to activate the visual indicator member based on the transceiver mechanism.

### BRIEF DESCRIPTION OF THE DRAWINGS

Exemplary embodiments of the present disclosure will be better understood and readily apparent to one of ordinary skill in the art from the following written description, by way of example only, and in conjunction with the drawings, in which:

FIG. 1A is a perspective view of a modular accessory device in an exemplary embodiment.

FIG. 1B is a schematic side view of the modular accessory device in the exemplary embodiment.

FIG. 1C is a schematic top view of the modular accessory device in the exemplary embodiment.

FIG. 1D is another perspective view of the modular accessory device in the exemplary embodiment.

FIG. 1E is a schematic cross-sectional top view of the modular accessory device in the exemplary embodiment.

FIG. 2A is a cross-sectional top view of a modular accessory device in an exemplary embodiment being coupled to a transmitter device.

FIG. 2B is a perspective view illustrating the modular accessory device being coupled to one transmitter device.

FIG. 2C is a perspective view illustrating the modular accessory device being coupled to two transmitter devices.

FIG. 3A is a perspective view showing external exemplary dimensions of a modular accessory device.

FIG. 3B is a schematic top view showing external exemplary dimensions of the modular accessory device.

FIG. 4 is a schematic diagram illustrating a connection of a modular accessory device of an exemplary embodiment to a transmitter device in an exemplary implementation.

FIG. 5A is a schematic diagram illustrating a modular accessory device coupled to one transmitter device in an exemplary embodiment.

FIG. 5B is a schematic flowchart for illustrating a process of powering up/booting up the transmitter device in the exemplary embodiment.

FIG. 6 is a schematic diagram illustrating a modular accessory device coupled to a first transmitter device and a second transmitter device in an exemplary embodiment.

FIG. 7A is a schematic drawing illustrating an exemplary circuit diagram of a first connector module and a second connector module in a modular accessory device in an exemplary embodiment.

FIG. 7B is a schematic drawing illustrating an exemplary circuit diagram between a power source and a power source controller in a modular accessory device in an exemplary embodiment.

FIG. 7C is a schematic drawing illustrating an exemplary circuit diagram of a visual indicator member of a modular accessory device in an exemplary embodiment.

FIG. 8 a schematic flowchart for illustrating a method of using a modular accessory device in an exemplary embodiment.

FIG. 9 is a schematic block diagram for illustrating a transmitter device in an exemplary embodiment.

### DETAILED DESCRIPTION

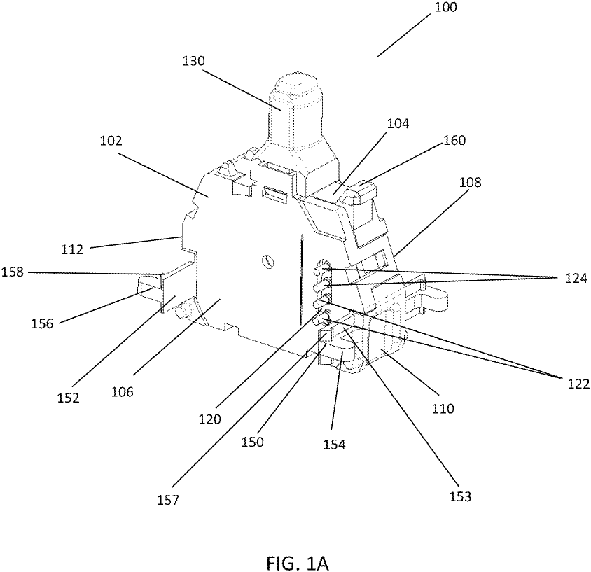

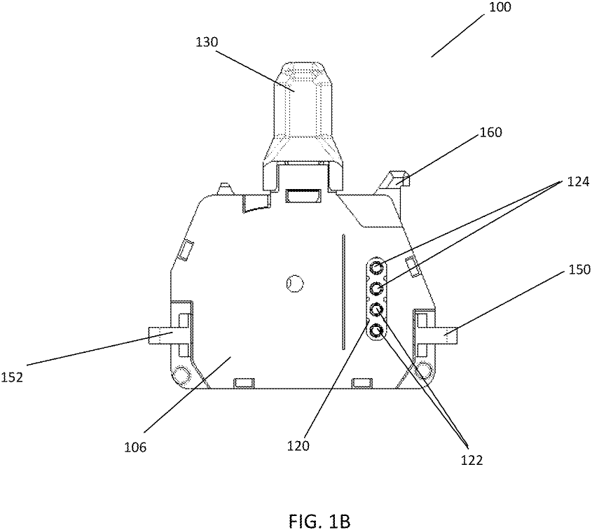

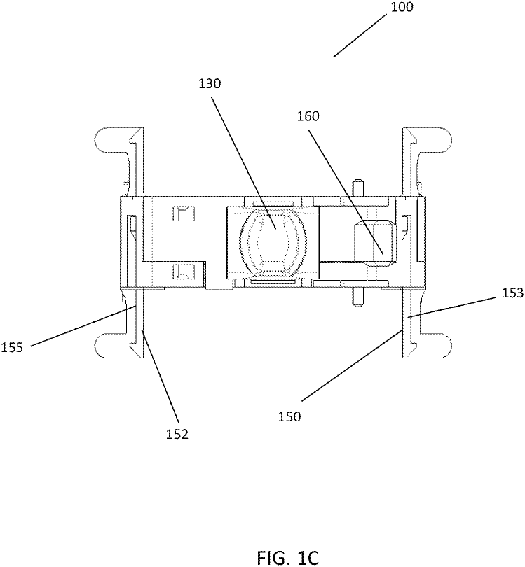

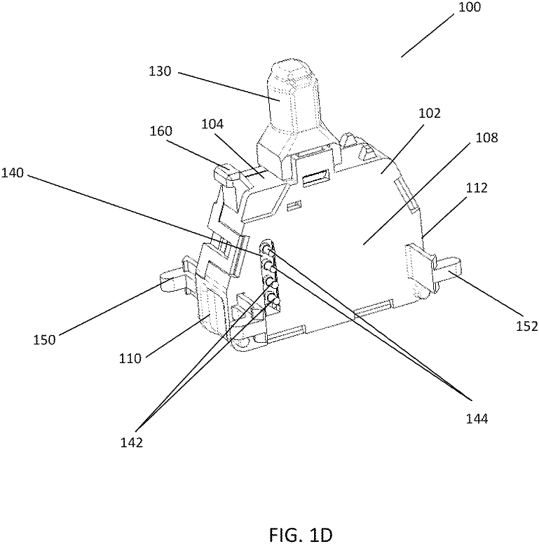

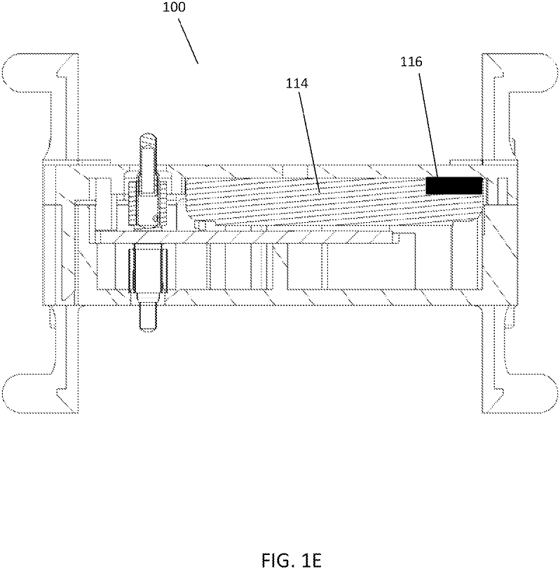

FIG. 1A is a perspective view of a modular accessory device in an exemplary embodiment. The view of the modular accessory device in FIG. 1A may be taken as from the front of the modular accessory device. FIG. 1B is a schematic side view of the modular accessory device in the exemplary embodiment. FIG. 1C is a schematic top view of the modular accessory device in the exemplary embodiment. FIG. 1E is a schematic cross-sectional top view of the modular accessory device in the exemplary embodiment.

In the exemplary embodiment as shown in FIG. 1A, the modular accessory device 100 is for coupling to a transmitter device (not shown). The transmitter device may be disposed adjacent to the modular accessory device 100. The transmitter device is for example a wireless transmitter as described in PCT Patent Application No. PCT/SG2021/050312. The modular accessory device 100 comprises a housing 102, a first connector module 120, a power source controller 116 and a visual indicator member 130. The power source controller 116 is arranged to be coupled to a power source 114.

The housing 102 comprises a first top surface 104, a bottom surface (not shown), a first side wall 106, a second side wall 108, a first back end 110 and a second back end 112. The first side wall 106 is opposite the second side wall 108, i.e. the first side wall 106 is disposed on an opposite side of the housing 102 from the second side wall 108. The first back end 110 is opposite the second back end 112, i.e. the first back end 110 is disposed on an opposite side or end of the housing 102 from the second back end 112.

The visual indicator member 130 is electrically coupled to the first connector module 120. The visual indicator member 130 is disposed in the modular accessory device 100. An extended portion of the visual indicator member 130 protrudes above the first top surface 104 of the housing 102. In the exemplary embodiment, the visual indicator member 130 comprises a light emitting diode (LED). The LED may be disposed in the extended portion of the visual indicator member 130. The visual indicator member 130 is capable of being housed within an external actuation device (not shown). For example, the external actuation device may be a pushbutton or a selector switch. For example, the exposed portion of the visual indicator member 130 may be housed within the external actuation device.

The first connector module 120 allows electrical coupling of the modular accessory device 100 to the transmitter device disposed adjacent the modular accessory device. For example, the transmitter device is termed a first transmitter device. For example, the first transmitter device may comprise a corresponding electrically conductive member to co-operate with the first connector module 120. The first connector module 120 is in the form of, but is not limited to, one or more pogo pins. As an example, the first connector module 120 may comprise one or more pogo pins while the first transmitter device may comprise an electrically conductive member with one or more exposed contact pads. The modular accessory device 100 and the first transmitter device can therefore be coupled together side-by-side and directly adjacent to each other. For example, the modular accessory device 100 can allow the power source 114 to be provided to the first transmitter device via the electrical coupling between the first connector module 120 and the electrically conductive member of the first transmitter device. The power source 114 is therefore external to the first transmitter device. For example, sufficient power may be provided by the modular accessory device 100 via the electrical coupling to allow the first transmitter device to receive an acknowledgement communication signal from a receiver. For example, the modular accessory device 100 may be controlled by the first transmitter device via the electrical coupling.

In the exemplary embodiment, the first connector module 120 is disposed on the first side wall 106 of the modular accessory device 100. For example, if the first connector module 120 comprises one or more pogo pins, the one or more pogo pins may be disposed perpendicular to the first side wall 106.

The first connector module 120 comprises a first input member 122. In the exemplary embodiment, the first input member 122 may receive at least two types of instructions/signals from the first transmitter device. In the exemplary embodiment, the first input member 122 is arranged to receive a signal from the first transmitter device to instruct a first provision of power from the power source 114 to the first transmitter device and to instruct a second provision of power to the visual indicator member 130. The visual indicator member 130 is arranged to be activated based on an indicator control signal received from the first transmitter device via the first input member 122.

The power source controller 116 is coupled to the first connector module 120. The power source controller may be, but is not limited to, a DC-DC regulator. As described, the power source controller 116 is further arranged to be coupled to the power source 114. The power source 114 may be, but is not limited to, a removable power source. For example, the power source 114 may be a replaceable/changeable battery, a coin cell battery etc. The power source 114 is disposed in the housing of the modular accessory device 100.

In the exemplary embodiment, the first connector module 120 further comprises a first output member 124 for transmitting the first provision of power to the first transmitter device. For example, when the signal to instruct a first provision of power from the power source 114 to the first transmitter device is received via the first input member 122 of the modular accessory device 100, the power source controller 116 provides power from the power source 114 of the modular accessory device 100 and transmits the first provision of power to the first transmitter via the first output member 124 of the modular accessory device 100. The power source controller 116 provides power from the power source 114 of the modular accessory device 100 as the second provision of power to the visual indicator member 130. When the indicator control signal from the first transmitter device is received via the first input member 122 of the modular accessory device 100, the visual indicator member 130 is activated. That is, with the second provision of power to the visual indicator member 130 and with the received indicator control signal from the first transmitter device, the visual indicator member 130 is activated. For example, the LED is switched on.

In the exemplary embodiment, the modular accessory device 100 provides visual feedback or indication to a user/operator by activation of the visual indicator member 130 to indicate the first transmitter device has received an acknowledgement communication signal from a corresponding receiver. This can usefully inform the user/operator that the receiver has received a communication signal from the first transmitter device and that the receiver has sent the acknowledgement communication signal that has in turn been received at the first transmitter device. The visual feedback or indication thus informs that communication has been set up between the first transmitter device and a corresponding receiver and is operating as intended.

The above exemplary embodiment provides the first connector module 120 for coupling to the first transmitter device. In the exemplary embodiment, another connector module is further provided for coupling to another transmitter device.

It will be appreciated that in other exemplary embodiments, only the first connector module 120 may be provided.

FIG. 1D is another perspective view of the modular accessory device 100 in the exemplary embodiment. The view of the modular accessory device in FIG. 1D may be taken as from an opposite side of the modular accessory device as compared to the view of FIG. 1A.

In the exemplary embodiment, as shown in FIG. 1D, the modular accessory device 100 further comprises a second connector module 140. The second connector module 140 is electrically coupled to the power source controller 116 and to the visual indicator member 130.

The second connector module 140 functions substantially similarly to the first connector module 120. The second connector module 140 allows electrical coupling of the modular accessory device 100 to a transmitter device disposed adjacent the modular accessory device 100. For example, such a transmitter device is termed a second transmitter device. For example, the second transmitter device may comprise a corresponding electrically conductive member to co-operate with the second connector module 140. The second connector module 140 is in the form of, but is not limited to, one or more pogo pins. As an example, the second connector module 140 may comprise one or more pogo pins while the second transmitter device may comprise an electrically conductive member with one or more exposed contact pads. The modular accessory device 100 and the second transmitter device can therefore be coupled together side-by-side and directly adjacent to each other. For example, the modular accessory device 100 can allow the power source 114 to be provided to the second transmitter device via the electrical coupling between the second connector module 140 and the electrically conductive member of the second transmitter device. The power source 114 is therefore external to the second transmitter device. For example, sufficient power may be provided by the modular accessory device 100 via the electrical coupling to allow the second transmitter device to receive an acknowledgement communication signal from a receiver. For example, the modular accessory device 100 may be controlled by the second transmitter device via the electrical coupling.

In the exemplary embodiment, the second connector module 140 is disposed on the second side wall 108 of the modular accessory device 100. For example, if the second connector module 140 comprises one or more pogo pins, the one or more pogo pins may be disposed perpendicular to the second side wall 108.

The second connector module 140 comprises a second input member 142. In the exemplary embodiment, the second input member 142 may receive at least two types of instructions/signals from the second transmitter device. In the exemplary embodiment, the second input member 142 is arranged to receive a signal from the second transmitter device to instruct the first provision of power from the power source 114 to the second transmitter device and to instruct the second provision of power to the visual indicator member 130. The visual indicator member 130 is arranged to be activated based on an indicator control signal received from the second transmitter device via the second input member 142.

In the modular accessory device 100, the power source controller 116 is coupled to both the first connector module 120 and the second connector module 140.

The visual indicator member 130 is electrically coupled to both the first connector module 120 and the second connector module 140.

In the exemplary embodiment, the second connector module 140 further comprises a second output member 144 for transmitting the first provision of power to the second transmitter device.

For example, when the signal to instruct a first provision of power from the power source 114 to the second transmitter device is received via the second input member 142 of the modular accessory device 100, the power source controller 116 provides power from the power source 114 of the modular accessory device 100 and transmits the first provision of power to the second transmitter via the second output member 144 of the modular accessory device 100. The power source controller 116 provides power from the power source 114 of the modular accessory device 100 as the second provision of power to the visual indicator member 130. When the indicator control signal from the second transmitter device is received via the second input member 142 of the modular accessory device 100, the visual indicator member 130 is activated. That is, with the second provision of power to the visual indicator member 130 and with the received indicator control signal from the second transmitter device, the visual indicator member 130 is activated. For example, the LED is switched on.

In the exemplary embodiment, besides being able to provide visual feedback or indication for a first transmitter device, the modular accessory device 100 provides visual feedback or indication to a user/operator by activation of the visual indicator member 130 to indicate the second transmitter device has received an acknowledgement communication signal from a corresponding receiver. This can usefully inform the user/operator that the receiver has received a communication signal from the second transmitter device and that the receiver has sent the acknowledgement communication signal that has in turn been received at the second transmitter device. The visual feedback or indication thus informs that communication has been set up between the second transmitter device and a corresponding receiver and is operating as intended.

In the exemplary embodiment, the modular accessory device 100 further comprises a mechanical transmitter mating member 150 disposed on the housing 102 of the modular accessory device 100. The mechanical transmitter member 150 is disposed at the first back end 110. It may be provided that another mechanical transmitter mating member 152 is disposed at the second back end 112 of the modular accessory device 100. In other exemplary embodiments, only the mechanical transmitter member 150 may be provided. The mechanical transmitter mating member e.g. 150, 152 is adapted to mechanically couple to at least one transmitter device which is disposed adjacent to the modular accessory device 100, i.e. adjacent to the first side wall 106 and/or the second side wall 108 of the housing 102, wherein the at least one transmitter device (not shown) comprises a complementary member for mating with the mechanical transmitter mating member e.g. 150, 152. The mechanical transmitter mating member e.g. 150, 152 extends from the first side wall 106 and/or the second side wall 108 of the housing 102. For example, where there are provided both the first connector module 120 and the second connector module 140, the mechanical transmitter mating member e.g. 150, 152 may extend from one or both of the first side wall 106 and the second side wall 108 for mechanically coupling two transmitter devices to the modular accessory device 101.

In the exemplary embodiment, the mechanical transmitter mating member e.g. 150, 152 is in the form of, but is not limited to, a snap-clip for mechanically coupling the at least one transmitter device. In the exemplary embodiment, the mechanical transmitter mating member e.g. 150, 152 comprises a spine e.g. 153, 155 which can guide within a groove of the complementary mating member of the at least one transmitter device. The spine e.g. 153, 155 is shown extending from both of the first side wall 106 and the second side wall 108. The mechanical transmitter mating member e.g. 150, 152 further comprises at least one protruding substantially L-shaped leading edge e.g. 154, 156 respectively distal from the first side wall 106 and/or the second side wall 108 and provided on an end of the spine e.g. 153, 155. Each L-shaped leading edge e.g. 154, 156 comprises a snap-fit hook e.g. 157, 158. In the exemplary embodiment, the mechanical transmitter mating member e.g. 150, 152 is made of, but is not limited to, plastic. In FIG. 1C, there is shown two mechanical transmitter mating members 150, 152 each extending from the first side wall 106 and the second side wall 108 of the housing 102. The two mechanical transmitter mating members 150, 152 each comprises the spine 153, 155 respectively. There are shown four protruding substantially L-shaped leading edges at the ends of the spines 153, 155. In other exemplary embodiments, the spines 153, 155 may be broken up into four separate spines, each extending from a side wall of the housing 102.

The modular accessory device 100 further comprises a mechanical actuator mating member 160 disposed on the first top surface 104 of the modular accessory device 100 wherein the mechanical actuator mating member 160 is adapted to mechanically couple to at least one external actuator device (not shown). The mechanical actuator mating member 160 is adapted to mechanically engage with or couple to the at least one external actuation device (not shown), e.g. when the at least one external actuation device (not shown) is disposed at the first top surface 104 of the modular accessory device 100. The mechanical actuator mating member 160 is in the form of, but is not limited to, a fixing hook and snap-clip respectively for mounting the modular accessory device 100 to the external actuation device. The external actuation device may be, but is not limited to, a pushbutton, a selector switch, a joy stick etc. The pushbutton, the selector switch, the joy stick etc may be made of plastic or metal but is not limited as such. For example, the external actuation device may also be a wired transmitter with a plunger for actuating the transmitter device.

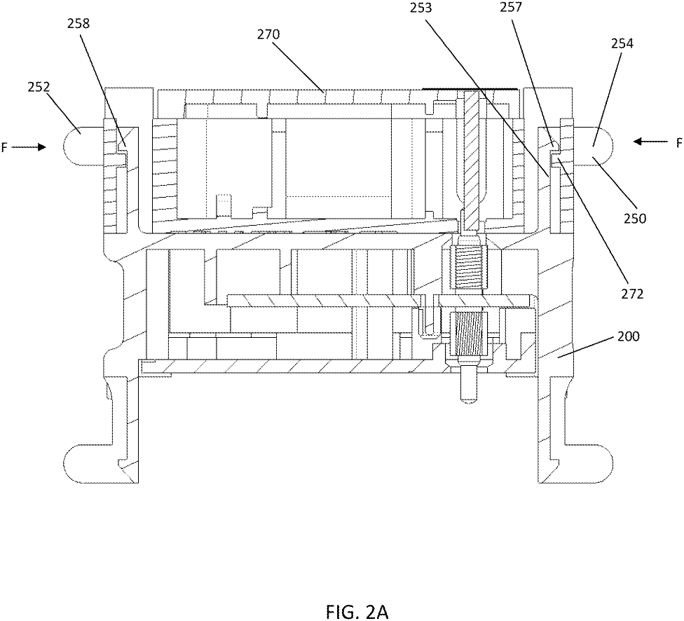

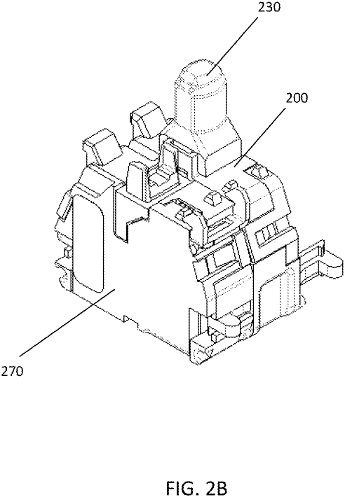

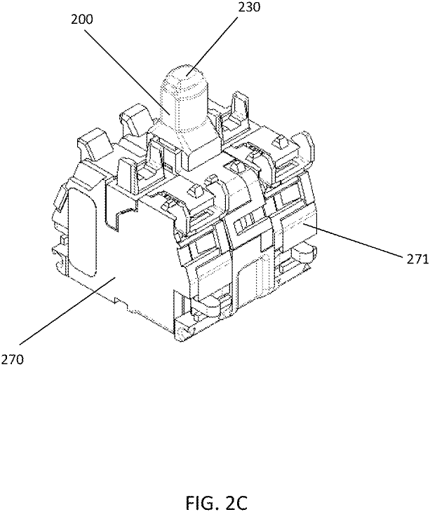

FIG. 2A is a cross-sectional top view of a modular accessory device in an exemplary embodiment being coupled to a transmitter device. FIG. 2B is a perspective view illustrating the modular accessory device being coupled to one transmitter device. FIG. 2C is a perspective view illustrating the modular accessory device being coupled to two transmitter devices.

In the exemplary embodiment, the modular accessory device 200 is substantially similar to the modular accessory device 100 of FIG. 1D. A mechanical transmitter mating member 250 is provided at one back end of the modular accessory device 200. Another mechanical transmitter mating member 252 is provided at another back end of the modular accessory device 200.

Referring to FIG. 2A, a L-shaped leading edge 254 is guided in the complementary member of the transmitter device 270. For example, a thoroughfare or a channel is provided with the transmitter device 270 to accommodate a spine 253. The spine 253 is shown schematically at the end proximal to the L-shaped leading edge 254. A snap-fit hook 257 is provided at the L-shaped leading edge 254. Another snap-fit hook 258 is shown schematically of another L-shaped leading edge of the mechanical transmitter mating member 252.

When the snap-fit hook 257 of the L-shaped leading edge 254 contacts a blocking component 272, e.g. a rib, of the transmitter device 270 that is disposed in the thoroughfare or the channel of the transmitter device 270, the snap-fit hook 257 is bent and snaps behind the blocking component 272 of the transmitter device. The bending may occur due to the motion of the spine 253 within the thoroughfare or the channel of the transmitter device 270. There is a snap-and-fit action between the snap-fit hook 257 of the modular accessory device 200 and the blocking component 272 of the transmitter device 270. The modular accessory device 200 is then securely fixed to the transmitter device 270 to form an assembled module. In the secured/fixed state, the end of the L-shaped leading edge 254 protrudes from its respective side of the assembled module. The above description is provided for the mechanical transmitter mating member 250. It will be appreciated that a similar process is taken for the another mechanical transmitter mating member 252.

In order to disengage/decouple the modular accessory device 200 from the transmitter device 270, a force F is applied on the protruding ends of the L-shaped leading edges e.g. 254 of the mechanical transmitter mating member 250 and the another mechanical transmitter mating member 252 of the modular accessory device 200. For the mechanical transmitter mating member 250, the force F may disengage the snap-fit hook 257 from the blocking component 272 of the transmitter device 270 and the spine 253 may then be withdrawn in a direction away from the blocking component 272 while within the thoroughfare or the channel of the transmitter device 270.

Referring to FIG. 2B, a shape of the housing of the modular accessory device 200 is substantially similar or complementary to a shape of a housing of the first transmitter device 270. This allows the modular accessory device 200 to be mechanically coupled to the first transmitter device 270 and form an assembled module. The first transmitter device 270 is mechanically coupled to the modular accessory device 200 via the snap-and-fit action between the snap-fit hook (compare 257 of FIG. 2A and e.g. 157 of FIG. 1A) of the modular accessory device 200 and the blocking component (compare 272 of FIG. 2A) of the first transmitter device 270.

In the exemplary embodiment, when the first transmitter device 270 is actuated, the first transmitter device 270 interacts with the modular accessory device 200 via a first connector module of the modular accessory device 200 and a complementary electrically conductive member of the first transmitter device 270 to, as an example only, activate a visual indicator member 230 of the modular accessory device 200.

Referring to FIG. 2C, a shape of a housing of the modular accessory device 200 is substantially similar or complementary to a shape of a housing of the first transmitter device 270 and a shape of a housing of a second transmitter device 271. This allows the modular accessory device 200 to be mechanically coupled to two different transmitters, i.e. the first transmitter device 270 and the second transmitter device 271. The first transmitter device 270 and the second transmitter device 271 are mechanically coupled to the modular accessory device 200 via the snap-and-fit action between the snap-fit hooks (compare 257, 258 of FIG. 2A and e.g. 157 of FIG. 1A) of the modular accessory device 200 and the respective blocking components (compare e.g. 272 of FIG. 2A) of the first transmitter device 270 and the second transmitter device 271.

When the first transmitter device 270 is actuated, the first transmitter device 270 interacts with the modular accessory device 200 via a first connector module of the modular accessory device 200 and a complementary electrically conductive member of the first transmitter device 270 to e.g. activate the visual indicator member 230 of the modular accessory device 200. When the second transmitter device 271 is actuated, the second transmitter device 271 interacts with the modular accessory device 200 via a second connector module of the modular accessory device 200 and a complementary electrically conductive member of the second transmitter device 271 to, as an example only, activate the visual indicator member 230 of the modular accessory device 200.

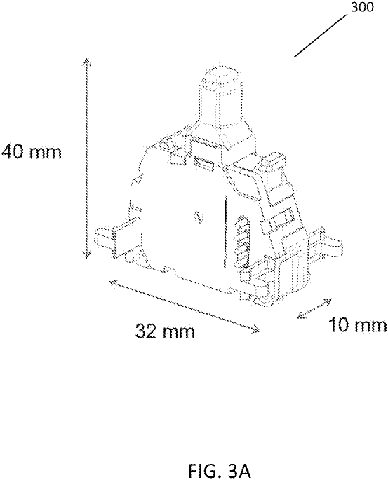

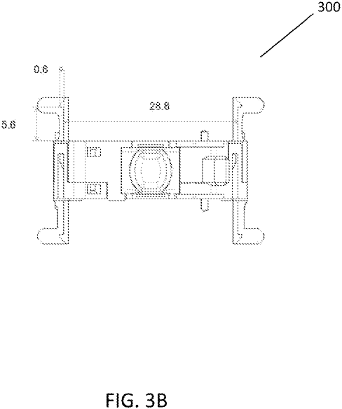

FIG. 3A is a perspective view showing external exemplary dimensions of a modular accessory device. FIG. 3B is a schematic top view showing external exemplary dimensions of the modular accessory device. The dimensions are shown so as to illustrate the small form factor of the modular accessory device of the exemplary embodiment.

In FIG. 3A, the external exemplary dimensions of the modular accessory device 300 are shown. A height of the modular accessory device 300 from a bottom surface (not shown) to a top end of an extended portion of a visual indicator member (compare e.g. 130 of FIGS. 1A and 1D) is shown as, but is not limited to, about 40 mm. A width of a housing (compare e.g. 102 of FIGS. 1A and 1D) of the modular accessory device 300 from a first side wall (compare e.g. 106 of FIG. 1A) to an opposing second side wall (compare e.g. 108 of FIGS. 1A and 1D) is shown as, but is not limited to, about 10 mm. A length of the housing (compare e.g. 102 of FIGS. 1A and 1D) from a first back end (compare e.g. 110 of FIGS. 1A and 1D) to an opposing second back end (compare e.g. 112 of FIGS. 1A and 1D) is shown as, but is not limited to, about 32 mm.

Referring to FIG. 3B, the length of the spine connected to one L-shaped leading edge (compare e.g. 154, 156 of FIG. 1A, 153, 155 of FIG. 1C, and 253 and 254 of FIG. 2A) of a mechanical transmitter mating member (compare e.g. 150, 152 of FIGS. 1A and 1D) is shown as, but is not limited to, about 5.6 mm. A length from a middle part of the spine connected to one L-shaped leading edge to a middle part of a spine connected to another L-shaped leading edge is shown as, but is not limited to, about 28.8 mm. A width of a snap-fit hook (compare e.g. 257 of FIG. 2A) protruding from an upper end wall of the L-shaped leading edge is shown as, but is not limited to, about 0.6 mm.

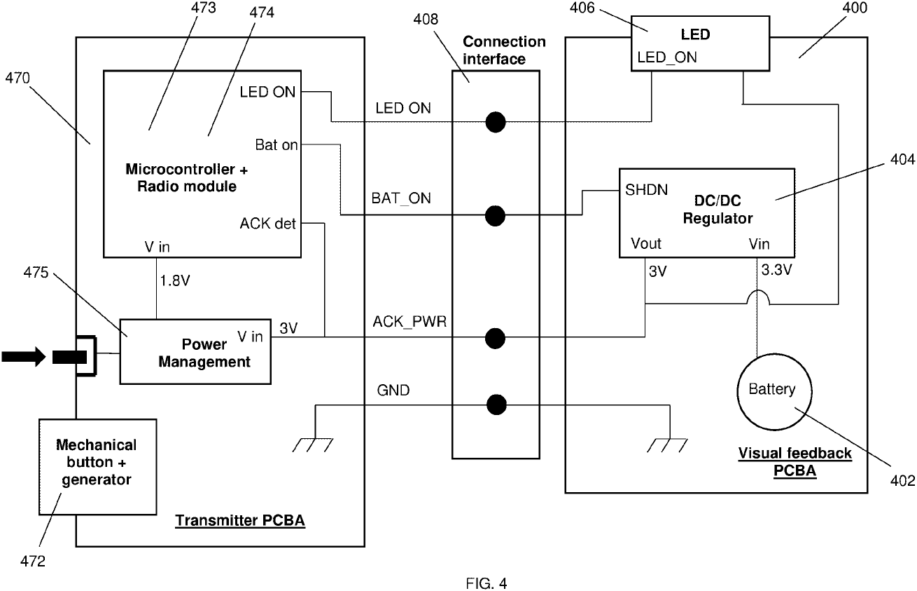

FIG. 4 is a schematic diagram illustrating a connection of a modular accessory device of an exemplary embodiment to a transmitter device in an exemplary implementation.

In FIG. 4, the modular accessory device 400 is simplified to show a power source 402, a power source controller 404 coupled to the power source 402, a visual indicator member 406 coupled to the power source controller 404 and a first connector module 408 coupled to the power source controller 404 and the visual indicator member 406. The power source 402 is in the form of, but is not limited to, a replaceable battery. The power source controller 404 may be, but is not limited to, a DC-DC regulator. The visual indicator member 406 is in the form of, but is not limited to, a LED. The first connector module 408 is in the form of, but is not limited to, one or more pogo pins. The first connector module 408 is termed as a connection interface 408.

The transmitter device 470 is simplified to show a mechanical actuator and a power generator module 472, a microcontroller 473, a transceiver/transmission mechanism 474, a power management system 475 and an electrically conductive member. For example, the electrically conductive member is in the form of, but is not limited to, a gold metal plated edge, one or more contact pad or one or more pogo pins. The power management module 475 provides a temporary power to the microcontroller 473 and the transceiver/transmission mechanism 473 when the mechanical actuator and the power generator module 472 is activated. That is, a power generator of the power generator module 472 generates energy/power to activate the transmitter device 470. In some exemplary embodiments, the power generator may be termed as an energy harvesting generator of a transmitter device.

The electrically conductive member of the transmitter device 470 is complementary to the first connector module 408 of the modular accessory device 400. The modular accessory device 400 and the transmitter device 470 are electrically coupled/connected to each other via the connection interface 408.

The microcontroller 473 of the transmitter device 470, together with the transceiver/transmission mechanism 474, controls the on/off function of the visual indicator member 406 of the modular accessory device 400. The microcontroller 473 further comprises an IO module comprising an ACK_DET IO pin, a BAT_ON IO pin and a LED_ON IO pin. The microcontroller 473 is connected to the power source controller 404 that is in turn coupled to the power source 402 of the modular accessory device 400 via the BAT_ON IO pin.

In the exemplary embodiment, the transmitter device 470 is a batteryless and wireless transmitter.

A basic cycle of the interaction process between the modular accessory device 400 and the transmitter device 470 is described below.

When the mechanical actuator of the transmitter device 470 is pressed/actuated, the power generator of the transmitter device 470 is activated. A power supply is provided from the power generator to the microcontroller 473 via the power management system 475 and the microcontroller 473 boots up or is activated. For example, a 1.8 V power supply is provided to the microcontroller 473 by the power generator. Typically, for a batteryless and wireless transmitter, the power generator generates a power supply just sufficient for activating a microcontroller of the transmitter and transmitting a signal.

In the exemplary embodiment, the microcontroller 473 samples the ACK_DET IO pin. If the ACK_DET IO pin is detected as a logic high, the microcontroller 473 shuts down. This logic may be implemented for a scenario of having more than one transmitter device coupled to the modular accessory device 400. That is, if it is detected that the ACK_DET IO pin is a logic high, it may mean that the transmitter device 470 is not the device commencing a communication and/or waiting for an acknowledgement communication signal from a receiver.

The power supply generated allows the microcontroller 473 to send a communication signal using the transceiver/transmission mechanism 474 to a receiver. After the communication signal is sent, the microcontroller 473 goes into a listening or receiving mode with usage of the modular accessory device 400.

In the exemplary embodiment, the microcontroller 473 sets the BAT_ON IO pin to a logic high which switches on the power source controller 404 (e.g. the DC-DC regulator) in the modular accessory device 400. That is, the transmitter device 470 sends a turn-on signal to the modular accessory device 400. The power source 402 (e.g. the battery) of the modular accessory device 400 is used as a voltage input for the power source controller 404 (e.g. the DC-DC regulator). For example, the power source controller 404 (e.g. the DC-DC regulator) regulates a stable output voltage of, for example, 3 V.

The output voltage (e.g. 3 V) from the modular accessory device 400 is then the main power supply for the transmitter device 470 during this time via the first connector module 408 of the modular accessory device 400 via an ACK_PWR line. The microcontroller 473 has the power for the listening or receiving mode, i.e. to wait for an acknowledgement communication signal from the receiver at the transceiver/transmission mechanism 474. As such, the turn-on signal instructs a first provision of power from the power source 402 to the transmitter device 470. In the exemplary embodiment, the power or the output voltage from the power source controller 404 is also provided, as a second provision of power, to the visual indicator member 406.

For the communication process between the transmitter device 470 and the corresponding receiver, when the receiver receives the communication signal from the transmitter device 470, the receiver sends back the acknowledgement communication signal to the transmitter device 470 to confirm that the signal communication between the transmitter device 470 and the receiver is successful. It will be appreciated that such communication may be by radio communication means and the signals may comprise radio frames.

On receiving the acknowledgement communication signal at the transceiver/transmission mechanism 474, the microcontroller 473 sets the LED_ON IO pin to a logic high. The LED_ON IO pin controls the visual indicator member 406 (e.g. the LED) on the modular accessory device 400. When the LED_ON IO pin is at a logic high, the microcontroller 473 controls/turns on the visual indicator member 406 (e.g. the LED) on the modular accessory device 400. For example, the visual indicator member 406 (e.g. the LED) flashes 2 times for 30 ms. As such, the signal via the LED_ON IO pin is an indicator control signal that may activate the visual indicator member 406.

In the exemplary embodiment, if the acknowledgement communication signal is not received by the transmitter device 470, the LED_ON IO pin is not set to a logic high (i.e. the LED_ON IO is at a logic low) and the microcontroller 473 of the transmitter device 470 shuts down/powers down which also shuts down/powers down the power source controller 404 (e.g. the DC-DC regulator) in the modular accessory device 400. For example, a predetermined time-out may be provided to the microcontroller 473 such that the microcontroller 473 shuts down upon reaching an expiry of the time-out. The predetermined time-out may be, for example but is not limited to, 1 ms.

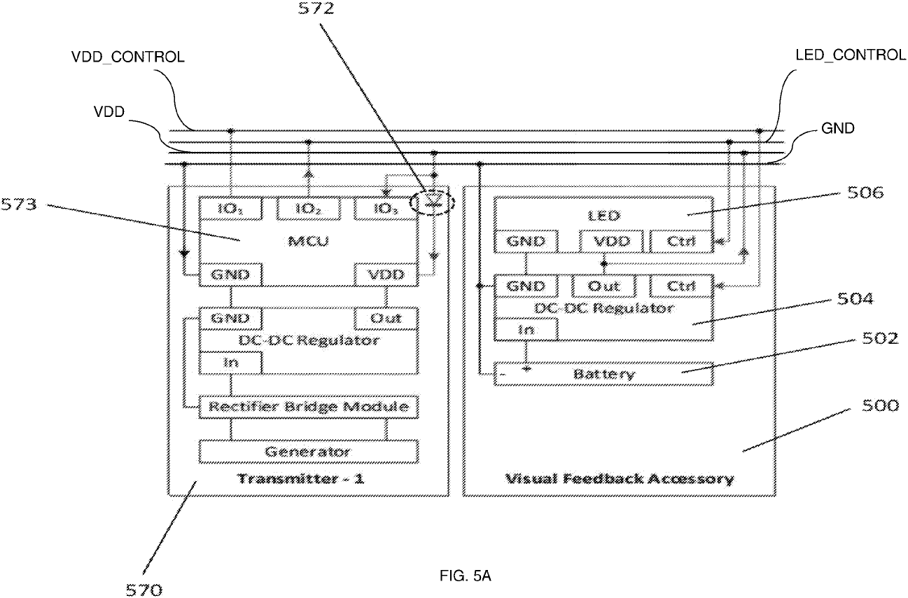

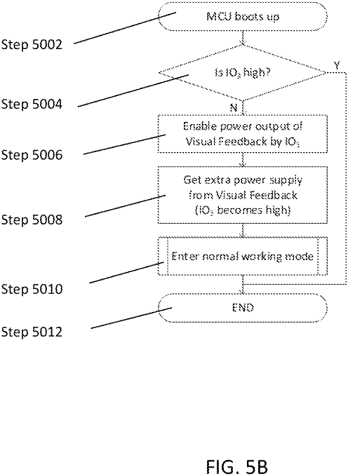

FIG. 5A is a schematic diagram illustrating a modular accessory device coupled to one transmitter device in an exemplary embodiment. The process of FIG. 5A is substantially similar to the process described with reference to FIG. 4 with different pin naming convention.

The modular accessory device 500 is denoted as a visual feedback accessory 500 in FIG. 5A. The transmitter device 570 is electrically coupled to the modular accessory device 500.

The transmitter device 570 comprises a microcontroller 573 that in turn comprises an IO₁ pin, an IO₂ pin and an IO₃ pin. In the description hereon, the references to the pins may simply refer to the pin name, e.g. IO₁, IO₂, IO₃ etc. The logic at the pins may be referred to as logic high or logic low and the like, and it will be appreciated that such logic can refer to a voltage output at the respective pin. The IO₁ pin is connected via a VDD_CONTROL line to a power source controller 504 (e.g. a DC-DC regulator) of the modular accessory device 500. The IO₂ pin is connected via a LED_CONTROL line to a visual indicator member 506 (e.g. comprising a LED) of the modular accessory device 500. The LED_CONTROL line controls the on/off state (or activation state) of the visual indicator member 506 (e.g. the LED) and allows for example the LED to switch on or off. The IO₃ pin is connected via a VDD line to the power source controller 504 (e.g. the DC-DC regulator) of the modular accessory device 500. A GND pin of the transmitter device 570 is connected via a GND line to a GND pin of the power source controller 504 (e.g. the DC-DC regulator) and a power source 502 (e.g. a battery) of the modular accessory device 500.

The VDD_CONTROL line functions to instruct a first provision of power to the transmitter device 570 and a second provision of power to the visual indicator member 506. The provisions of power are from the output of the power source controller 504 that is coupled to the VDD line.

The IO₁ logic of the transmitter device 570 controls the power source controller 504 (e.g. the DC-DC regulator) of the modular accessory device 500 via the VDD_CONTROL line. The power source 502 (e.g. the battery) of the modular accessory device is not always on or not being drained at all times. The power source 502 (e.g. the battery) is only drained by the power source controller 504 via control by the IO₁ logic.

When a high logic is detected at IO₁, the power source controller 504 (e.g. the DC-DC regulator) is activated via the VDD_CONTROL line. IO₁ can be at a logic high if the transmitter device 570 is actuated to transmit a communication signal. That is, a generated power supply within the transmitter device 570 provides a VDD voltage to the microcontroller 573 of the transmitter device 570. Compare the diode 572 between the VDD port of the microcontroller 573 and IO₃. The initial generated VDD within the transmitter device 570 turns on the diode and therefore, IO₃ is at a logic low. When IO₃ is low at the first determination by the microcontroller 573, this signifies to the microcontroller 573 that it is the transmitter device 570 that is about to transmit a signal and/or is about to wait for an acknowledgment communication signal from a receiver.

With the high signal along the VDD_CONTROL line, the power source 502 (e.g. the battery) of the modular accessory device 500 is then drained by the power source controller 504 that has been activated. When the power source controller 504 (e.g. the DC-DC regulator) is at an on state (or activated state), a voltage and/or a current is output from the power source controller 504 and is provided as the VDD voltage to the microcontroller 573. IO₃ is also connected to the VDD line and IO₃ changes to a logic high.

In the exemplary embodiment, the transmitter device 570 is therefore powered by power source 502 (e.g. the battery) via the power source controller 504 (e.g. the DC-DC regulator) and is able to send a communication signal and is able to have sufficient power to wait for an acknowledgment communication signal from a receiver. When the acknowledgment communication signal is received by the transmitter device 570, the microcontroller 573 changes IO₂ to a logic high and thereby instructs via the LED_CONTROL line to activate the visual indicator member 506 (e.g. the LED).

FIG. 5B is a schematic flowchart for illustrating a process of powering up/booting up the transmitter device in the exemplary embodiment.

At step 5002, the microcontroller 573 (denoted as MCU in FIG. 5B) of the transmitter device 570 is first powered up/booted up by energy/power generated by a power generator of the transmitter device 570 for the transmitter device 570 to begin working. At step 5004, it is then determined, as a first determination, whether a logic high or a logic low is detected at the IO₃ pin. If a logic high is detected at the IO₃ pin, the process loops to step 5012 where the microcontroller 573 shuts down and the powering up/booting process of the transmitter device ends. If a logic low is detected at the IO₃ pin, at step 5006, the IO₁ pin is set on a logic high and enables the modular accessory device 500 to generate a power output. At step 5008, the power source 502 (e.g. the battery) via the power source controller 504 provides a power output of the modular accessory device 500. The transmitter device 570 receives the additional power supply from the modular accessory device 500 and the IO₃ pin changes to a logic high. At step 5010, the transmitter device 570 then enters into a normal working mode, e.g. to send communication frames or a signal, and is powered by the power source 502 (e.g. the battery) to wait for and receive an acknowledgement communication signal from a receiver.

After the acknowledgement communication signal from the receiver is received, IO₂ is switched to high logic to activate the visual indicator member 506 of the modular accessory device 500. At step 5012, the microcontroller 573 of the transmitter device 570 shuts down/powers down and the process ends.

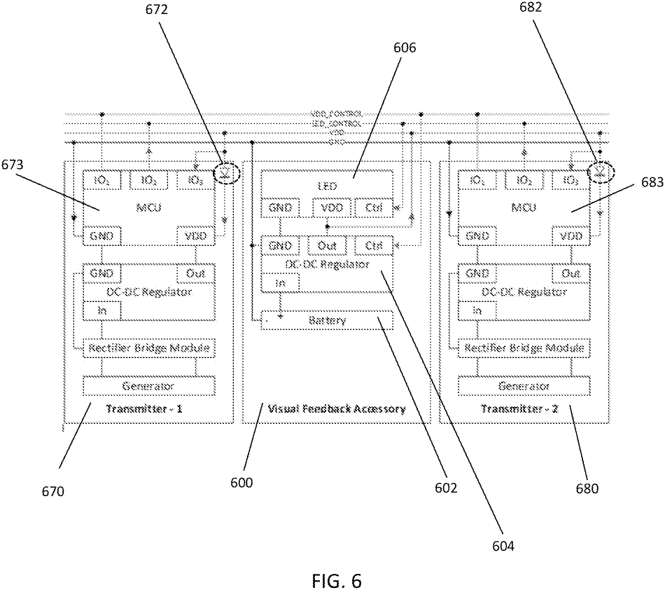

FIG. 6 is a schematic diagram illustrating a modular accessory device coupled to a first transmitter device and a second transmitter device in an exemplary embodiment.

Similar to FIG. 5A, the modular accessory device 600 is denoted as a visual feedback accessory. The first transmitter device 670 and the second transmitter device 680 is electrically coupled to the modular accessory device 600.

The first transmitter device 670 and the second transmitter device 680 function substantially the same as the transmitter device 570 of FIG. 5A. The modular accessory device 600 functions substantially the same as the modular accessory device 500 of FIG. 5A.

The IO₁ logic of any one of the first transmitter device 670 and the second transmitter device 680 controls a power source controller 604 (e.g. a DC-DC regulator) of the modular accessory device 600 via the VDD_CONTROL line. The power source 602 (e.g. a battery) of the modular accessory device 600 is not always on or not being drained at all times. The power source 602 (e.g. the battery) is only drained by the power source controller 604 via control by the IO₁ logic of any one of the first transmitter 670 or the second transmitter device 680.

For example, when a high logic is detected at IO₁ of the first transmitter device 670, the power source controller 604 (e.g. the DC-DC regulator) is activated via the VDD_CONTROL line. IO₁ can be at a logic high if the transmitter device 670 is actuated to transmit a communication signal. That is, a generated power supply within the transmitter device 670 provides a VDD voltage to the microcontroller 673 of the transmitter device 670. Compare the diode 672 between the VDD port of the microcontroller 673 and IO₃. The initial generated VDD within the transmitter device 670 turns on the diode and therefore, IO₃ is at a logic low. When IO₃ is low at the first determination by the microcontroller 673, this signifies to the microcontroller 673 that it is the transmitter device 670 that is about to transmit a signal and/or is about to wait for an acknowledgment communication signal from a receiver.

With the high signal along the VDD_CONTROL line, the power source 602 (e.g. the battery) of the modular accessory device 600 is then drained by the power source controller 604 that has been activated. When the power source controller 604 (e.g. the DC-DC regulator) is at an on state (or activated state), a voltage and/or a current is output from the power source controller 604 and is provided as the VDD voltage to the microcontroller 673. IO₃ is also connected to the VDD line and IO₃ changes to a logic high.

In the exemplary embodiment, the first transmitter device 670 is therefore powered by power source 602 (e.g. the battery) via the power source controller 604 (e.g. the DC-DC regulator) and is able to send a communication signal and is able to have sufficient power to wait for an acknowledgment communication signal from a receiver. When the acknowledgment communication signal is received by the first transmitter device 670, the microcontroller 673 changes IO₂ of the first transmitter device 670 to a logic high and thereby instructs via the LED_CONTROL line to activate the visual indicator member 606 (e.g. the LED).

In the exemplary embodiment, with the voltage and/or current output from the power source controller 604 provided as the VDD voltage, a microcontroller 683 of the second transmitter device 680 obtains the power supply and is activated to wake up/boot up. Compare a diode 682 in the second transmitter device 680. At a first determination of the IO₃ pin, it is determined that IO₃ of the second transmitter device 680 is initially at a logic high. When IO₃ is high at the first determination by the microcontroller 683 at the second transmitter device 680, this signifies to the microcontroller 683 that it is not the second transmitter device 680 that is about to transmit a signal and/or is about to wait for an acknowledgment communication signal from a receiver.

Referring to FIG. 5B, it is observed that step 5004 provides a determination to the respective microcontroller 673, 683 of each transmitter device 670, 680 on whether to proceed to steps 5006 to 5010 or loop to step 5012.

For the first transmitter device 670 of the exemplary embodiment, at step 5004, it is determined that the first determination at IO₃ is low and the process proceeds through steps 5006 to step 5010, i.e. the first transmitter device 670 then enters into a normal working mode and is powered by the power source 602 (e.g. the battery) to e.g. transmit a communication signal and to wait for and receive an acknowledgement communication signal from a receiver.

On the other hand, for the second transmitter device 680 of the exemplary embodiment which is not activated by an operator or user, when the first transmitter device 670 enables the modular accessory device 600 to generate the power output, the power output is also provided to the second transmitter device 680. The microcontroller 683 of the second transmitter device 680 boots up/powers up (compare step 5002 of FIG. 5B). At step 5004, a logic high is detected at the IO₃ pin of the second transmitter device 680. The process loops to step 5012, that is, the microcontroller 683 of the second transmitter device 680 shuts down/powers down and the powering up/booting process of the second transmitter device 680 ends.

As such, in the above exemplary embodiment, the modular accessory device 600 may work with two transmitter devices 670, 680 to provide power simultaneously to both transmitter devices 670, 680 (if needed) for both transmitter devices 670, 680 to send respective communication signals and to wait for respective acknowledgement communication signals. The modular accessory device 600 can also allow visual indications simultaneously for both transmitter devices 670, 680 (if needed). If only one transmitter device e.g. 670 is actuated for transmitting a communication signal, the modular accessory device 600 can provide power to the actuated transmitter device e.g. 670 and also allow visual indication for the actuated transmitter device e.g. 670. The unactuated transmitter device e.g. 680 can determine that it is not the transmitter device that has been actuated to transmit a communication signal, to obtain power from the modular accessory device 600 and/or to utilise the visual indicator member of the modular accessory device 600. The unactuated transmitter device e.g. 680 may then shut down (see step 5012) until it is actuated.

For example, a firmware with a detection process of the interactions may be provided to each of the transmitter devices 670, 680 so that the transmitter devices 670, 680 can work with the modular accessory device 600.

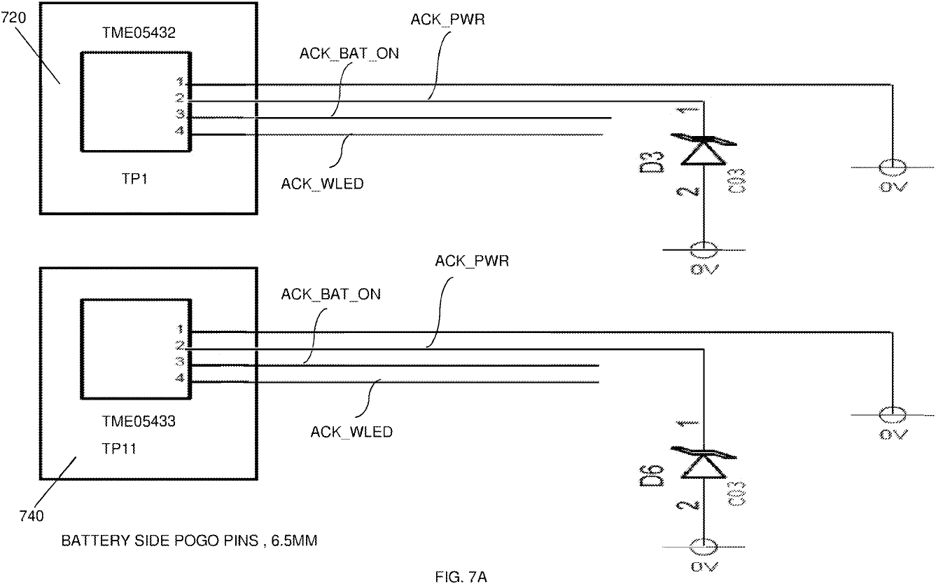

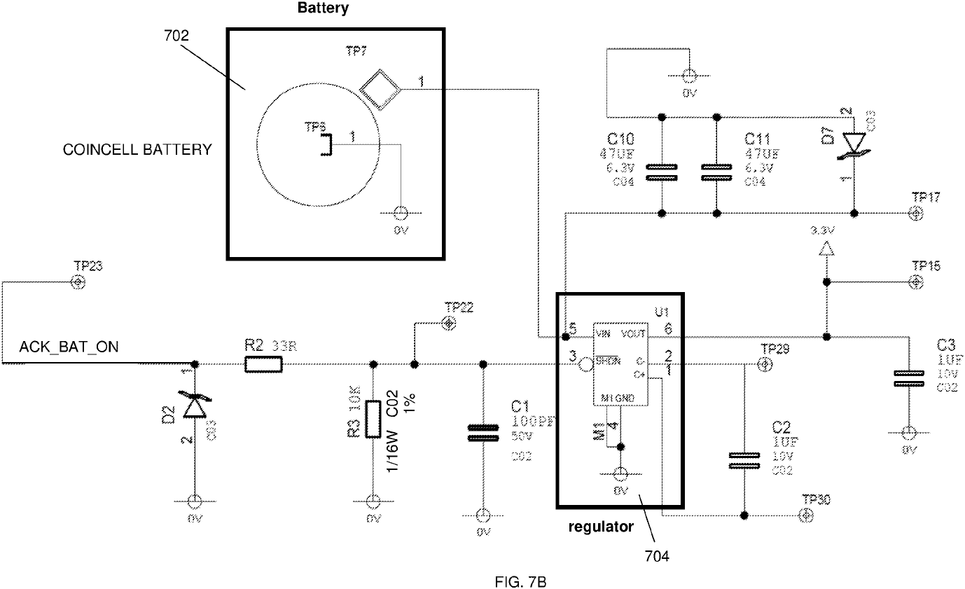

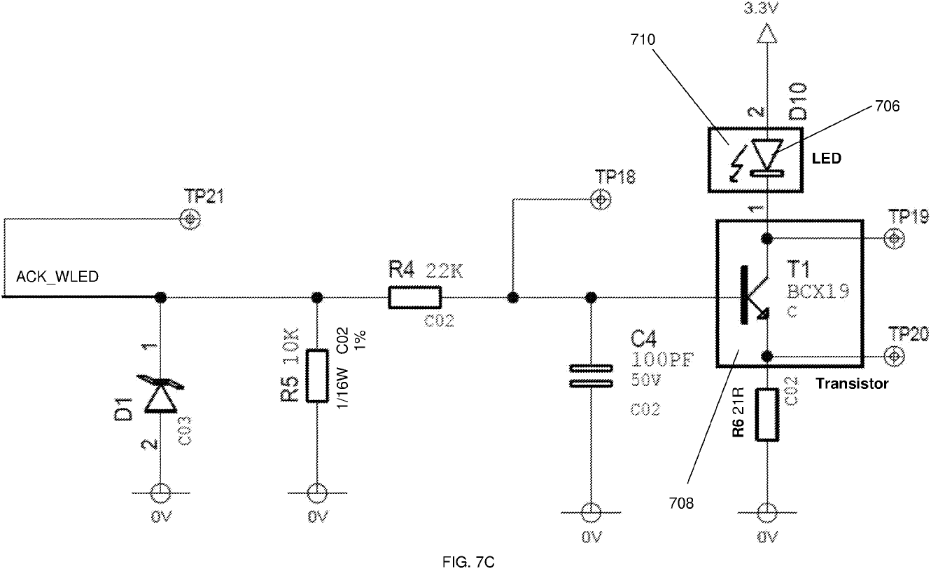

FIG. 7A is a schematic drawing illustrating an exemplary circuit diagram of a first connector module and a second connector module in a modular accessory device in an exemplary embodiment.

In the exemplary embodiment, two connection interfaces between the modular accessory device and two adjacent transmitter devices are formed/enabled by the first connector module 720 and the second connector module 740. For example, the first connector module 720 may couple to an electrically conductive member (not shown) of a first transmitter device and the second connector module 740 may couple to an electrically conductive member (not shown) of a second transmitter device. The first connector module 720 and the second connector 740 module are, for example only, multiple pogo pins. The first connector module 720 and the second connector module 740 are respectively disposed on a first side wall and an opposing second side wall of a housing of the modular accessory device. The first connector module 720 comprises a first input member and a first output member. For example, the first input member comprises two pogo pins and the first output member comprises two pogo pins. The second connector module 720 comprises a second input member and a second output member. For example, the second input member comprises two pogo pins and the second output member comprises two pogo pins. The connection interfaces between the modular accessory device and an adjacent first transmitter device and an adjacent second transmitter device is formed/enabled/operated via the pogo pins. The pogo pins of the first connector module 720 and the pogo pins of the second connector module 740 may be mirrored on the first side wall and the opposing second side wall of the modular accessory device.

In the example, Line 1 of both the first connector module 720 and the second connector module 740 are connected to ground.

In the example, Line 2 (i.e. connection associated to ACK_PWR) of both the first connector module 720 and the second connector module 740 may receive power from a power source to transmit to a first transmitter device and/or a second transmitter device respectively based on a high/low logic of, for example, a ACK_DET IO of the first transmitter device and/or the second transmitter device. Compare, for example, the description of FIG. 4.

In the example, Line 3 (i.e. connection associated to ACK_BAT ON) controls a power source controller (for example a DC-DC regulator) of the modular accessory device based on a high/low logic of, for example, a BAT_ON IO of the first transmitter device and/or the second transmitter device. Compare, for example, the description of FIG. 4.

In the example, Line 4 (i.e. connection associated to ACK_WLED) controls the on/off state of a visual indicator member of the modular accessory device based on a high/low logic of, for example, a LED_ON IO of the first transmitter device and/or the second transmitter device. Compare, for example, the description of FIG. 4.

FIG. 7B is a schematic drawing illustrating an exemplary circuit diagram between a power source and a power source controller in a modular accessory device in an exemplary embodiment.

In the exemplary embodiment, the power source 702 is denoted by, for example, a replaceable battery or a coin cell battery. The power source controller 704 is denoted by, for example, a DC-DC regulator. The power source 702 (e.g. the battery) is electrically connected to the power source controller 704 (e.g. the DC-DC regulator). The power of the power source 702 (e.g. the battery) is regulated by the power source controller 704 (e.g. the DC-DC regulator). The power source controller 704 (e.g. the DC-DC regulator) is controlled by high/low logic input from a ACK_BAT_ON IO of an adjacent transmitter device which may be connected/coupled to the modular accessory device. When a logic high is detected at the ACK_BAT_ON IO of the transmitter device, the power source controller 704 (e.g. the DC-DC regulator) of the modular accessory device switches on. The power source 702 (e.g. the battery) is used as an voltage input for the power source controller 704 (e.g. the DC-DC regulator).

FIG. 7C is a schematic drawing illustrating an exemplary circuit diagram of a visual indicator member of a modular accessory device in an exemplary embodiment. The visual indicator member comprises a visual indicator element and a control element for the visual indicator element. For example, the visual indicator member may comprise a lighting element and an activation control coupled to the lighting element.

In the exemplary embodiment, the visual indicator member 710 comprises, for example, a LED or LED light 706. The visual indicator member 710 uses power from the power source controller (e.g. 704). The visual indicator member 710 comprises a transistor 708 that can control the LED 706. The transistor 708 is connected to, for example, a LED_ON IO of a transmitter device. When a high logic is detected at the LED_ON IO of the transmitter device via a ACK_WLED line, the transistor 708 switches on and the LED 706 switches on (or is activated). Thus, for example, the transistor 708 functions as the control element of the visual indicator member 710 to activate the lighting element (e.g. the LED 706).

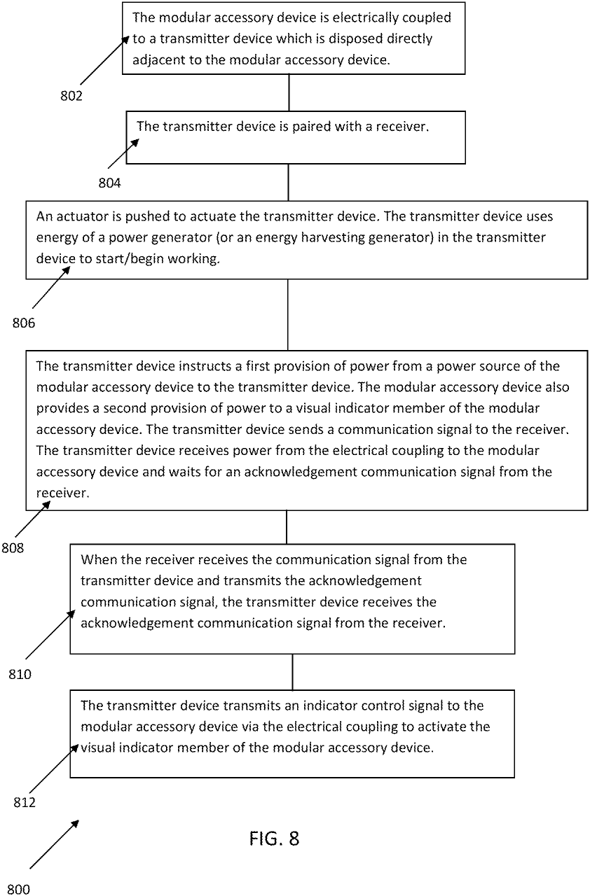

FIG. 8 a schematic flowchart 800 for illustrating a method of using a modular accessory device in an exemplary embodiment.

At step 802, the modular accessory device is electrically coupled to a transmitter device which is disposed directly adjacent to the modular accessory device. At step 804, the transmitter device is paired with a receiver. At step 806, an actuator is pushed to actuate the transmitter device. The transmitter device uses energy of a power generator (or an energy harvesting generator) in the transmitter device to start/begin working. At 808, the transmitter device instructs a first provision of power from a power source of the modular accessory device to the transmitter device. The modular accessory device also provides a second provision of power to a visual indicator member of the modular accessory device. The transmitter device sends a communication signal to the receiver. The transmitter device receives power from the electrical coupling to the modular accessory device and waits for an acknowledgement communication signal from the receiver. At step 810, when the receiver receives the communication signal from the transmitter device and transmits the acknowledgement communication signal, the transmitter device receives the acknowledgement communication signal from the receiver. At step 812, the transmitter device transmits an indicator control signal to the modular accessory device via the electrical coupling to activate the visual indicator member of the modular accessory device.

In the present disclosure, a transmitter device that can work with a modular accessory device as described in exemplary embodiments is also provided. The transmitter device is a batteryless transmitter device that may couple to a modular accessory device. The transmitter device may preferably be a wireless transmitter device.

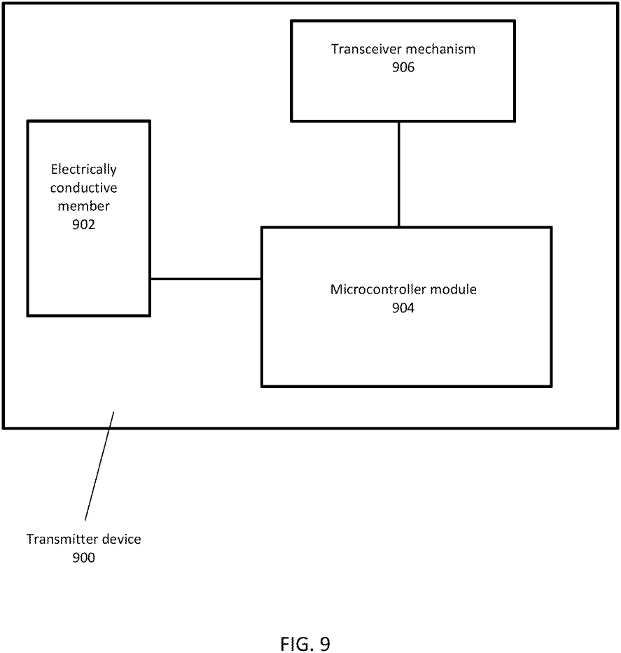

FIG. 9 is a schematic block diagram for illustrating a transmitter device in an exemplary embodiment. The transmitter device 900 is capable of coupling to a modular accessory device. The transmitter device 900 comprises at least one electrically conductive member 902 disposed on at least one side wall of the transmitter device 900. The at least one electrically conductive member 902 is arranged to allow electrical coupling to a first connector module of a modular accessory device. Further, the transmitter device 900 comprises a microcontroller module 904 that is coupled to the at least one electrically conductive member 902. The transmitter device 900 also comprises a transceiver mechanism 906 coupled to the microcontroller module 904. The transceiver mechanism 906 may transmit and receive signals or communicate with a receiver.

In the exemplary embodiment, a power generator (not shown) of the transmitter device 900 generates energy/power to activate the transmitter device 900 (see e.g. step 806 of FIG. 8). The transmitter device 900 may transmit a signal to a receiver and obtain power from the modular accessory device to wait for an acknowledgement communication signal from the receiver. The microcontroller module 904 is capable of transmitting a signal to the modular accessory device to instruct a first provision of power from a power source of the modular accessory device to the transmitter device 900. Such a signal also instructs a second provision of power from the power source of the modular accessory device to a visual indicator member of the modular accessory device. Such a signal may be termed as an accessory device turn-on signal in some exemplary embodiments. Compare, for example, the description of IO₁ in exemplary embodiments described with reference to FIGS. 5A and 5B. Thus, with the first provision of power, the microcontroller module 904 may be powered to wait for the acknowledgement communication signal from the receiver at the transceiver mechanism 906. In the exemplary embodiment, the microcontroller module 904 is capable of transmitting an indicator control signal to the modular accessory device to activate the visual indicator member based on the transceiver mechanism 906. For example, upon receipt of the acknowledgement communication signal at the transceiver mechanism 906, the microcontroller module 904 can transmit an indicator control signal to the modular accessory device to activate the visual indicator member. Compare, for example, the description of IO₂ in exemplary embodiments described with reference to FIG. 5A.

In the exemplary embodiment, the microcontroller module 904 may comprise a determination mechanism to determine whether to transmit a signal to the modular accessory device to instruct the first provision of power from the power source of the modular accessory device to the transmitter device 900. Compare, for example, step 5004 of FIG. 5B and for example, the description of the IO₃ logic high/low first determination upon boot up of the microcontroller.

The above described exemplary embodiments may provide a modular accessory device for connection to an adjacent batteryless and wireless transmitter. The modular accessory device may provide a visual feedback to an operator of an industrial control unit. The industrial control unit may be controlled or actuated via an actuator, for example a pushbutton, a selector switch, a joy stick etc. The wireless transmitter can send a communication signal to a receiver. If the communication signal is received by the receiver, the receiver sends back an acknowledgement communication signal to the wireless transmitter. This may usefully activate or turn on a visual indication member of the modular accessory device to notify the operator that the communication signal is received by the receiver. This allows the operator to determine conclusively whether the communication signal is received by the receiver.

The modular accessory device provides an external power to a transmitter device to wait for the acknowledgement communication signal from the receiver. Otherwise, without the external power supply, the batteryless and wireless transmitter does not typically have enough power to stay powered on. For example, without the external power, the batteryless and wireless transmitter can typically only stay on for 6 ms. Therefore, for conventional products, there is insufficient power to wait for the acknowledgement communication signal. With the modular accessory device and its external power supply, the batteryless and wireless transmitter can stay on longer for e.g. 90 ms to wait for the acknowledgement communication signal.

The modular accessory device allows the transmitter device to achieve a small form factor since the transmitter device does not need to have a large power generator or power supply internally, particularly for providing visual indicators relating to acknowledgement communication signals from a receiver.

The power for the modular accessory device is provided by a power source, for example, a coin cell battery, inside the modular accessory device. The power source is not required to be on a permanently-on state. Therefore, the modular accessory device is not constantly drawing down or draining the battery power. The power source may be switched to an on state (or activated state) when a power source controller of the modular accessory device switches on. This may reduce a wastage of power.

The power source of the modular accessory device provides enough power for the transmitter device to receive the acknowledgement communication signal from the relevant receiver.

The power source of the modular accessory device, being a separate power source from the power generator of the transmitter device, allows the visual indicator member to be activated for a longer time and at a brighter intensity.

In some exemplary embodiments, the modular accessory device can connect to two different transmitter devices at the same time and detect which of the two transmitter devices are being actuated at any time. This allows an operator to determine that the communication signal from the desired transmitter device is received by the relevant receiver.

Since the visual indicator member of the modular accessory device can be connected to two adjacent transmitter devices, the visual indicator member can be activated for each transmitter device separately when the acknowledgement communication signal is received by the relevant transmitter device. Therefore, the modular accessory device may be used with a selector switch. The first position of the selector switch may correspond to a first transmitter device and the second position of the selector switch may correspond to a second transmitter device.

The modular accessory device being modular in nature can be connected/disconnected from the transmitter device(s) when the need arises, without compromising or negatively affecting the performance of the machinery / industrial control unit(s). The modular accessory device can be connected to the transmitter device to add a functionality to the transmitter device, i.e. for receiving an acknowledgement communication signal from a receiver. Due to the modular nature of the modular accessory device, the transmitter device can be used on its own without the modular accessory device should the need arises. Further, since the modular accessory device is a separate device from the transmitter device, this allows the transmitter device to be formed with a small form factor.

Due to its modular nature, the modular accessory device can be used together/associated with different transmitter devices. This removes the need to provide a specific visual indication module/member for the various different types of transmitter devices.

Most of the components for instructing the modular accessory device to start operation, for example the logic control for activation of the modular accessory device and the transceiver/transmission mechanism, are contained in the transmitter device. The modular accessory device comprises only a small number of components, for example the power source, the power source controller and the visual indication member. This may be achieved due to the reliability of the connection interface(s) between the modular accessory device and the transmitter device(s), i.e. the connector module(s) of the modular accessory device and the complementary electrically conductive member(s) of the transmitter device(s). With the majority of components for instructing the modular accessory device provided externally of the modular accessory device (i.e. within the transmitter device(s)), this may significantly reduce the cost and complexity of producing/manufacturing the modular accessory device.

The mechanical transmitter mating member of the modular accessory device being complementary to a corresponding member of the transmitter device, together with the snap-fit hook of the mechanical transmitter mating member, allows the modular accessory device and the adjacent transmitter device to be securely coupled/connected to each other.

The terms “coupled” or “connected” as used in this description are intended to cover both directly connected or connected through one or more intermediate means, unless otherwise stated.

The terms “configured to (perform a task/action)”, “configured for (performing a task/action)” and the like as used in this description include being programmable, programmed, connectable, wired or otherwise constructed to have the ability to perform the task/action when arranged or installed as described herein. The terms “configured to (perform a task/action)”, “configured for (performing a task/action)” and the like are intended to cover “when in use, the task/action is performed”, e.g. specifically to and/or specifically configured to and/or specifically arranged to and/or specifically adapted to do or perform a task/action.

The term “and/or”, e.g., “X and/or Y” is understood to mean either “X and Y” or “X or Y” and should be taken to provide explicit support for both meanings or for either meaning.

The terms “associated with”, “related to” and the like used herein when referring to two elements refers to a broad relationship between the two elements. The relationship includes, but is not limited to, a physical, a chemical or a biological relationship. For example, when element A is associated with element B, elements A and B may be directly or indirectly attached to each other or element A may contain element B or vice versa.

The terms “exemplary embodiment”, “example embodiment”, “exemplary implementation”, “exemplarily” and the like used herein are intended to indicate an example of matters described in the present disclosure. Such an example may relate to one or more features defined in the claims and is not necessarily intended to emphasise a best example or any essentialness of any features.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initializing”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialized device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the invention.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The exemplary embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the exemplary embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For an example, when “comprising” is used, reference to a “one” feature is also intended to be a reference to “at least one” of that feature. Terms such as “consisting”, “consist”, and the like, may, in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/-5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. It is to be appreciated that the individual numerical values within the range also include integers, fractions and decimals. Furthermore, whenever a range has been described, it is also intended that the range covers and teaches values of up to 2 additional decimal places or significant figures (where appropriate) from the shown numerical end points. For example, a description of a range of 1% to 5% is intended to have specifically disclosed the ranges 1.00% to 5.00% and also 1.0% to 5.0% and all their intermediate values (such as 1.01%, 1.02% ... 4.98%, 4.99%, 5.00% and 1.1%, 1.2% ... 4.8%, 4.9%, 5.0% etc.,) spanning the ranges. The intention of the above specific disclosure is applicable to any depth/breadth of a range.

In the described exemplary embodiments, the first connector module and the second connector module are described to be in the form of one or more pogo pins. However, it is to be appreciated that the exemplary embodiments are not limited as such. The first connector module and the second connector module may be in the form of, but not limited to, a gold plated edge or one or more contact pads. If so, then a complementary electrically conductive member of a transmitter device may be in the form of, for example, one or more pogo pins. For example, if there are four pogo pins disposed for the complementary electrically conductive member of a transmitter device, then four contact pads are disposed for each of the first connector module and the second connector module. The first connector module and the second connector module may be in any form so long as each may electrically couple the modular accessory device to the transmitter device(s) disposed directly adjacent to the modular accessory device.

In the described exemplary embodiments, the power source (e.g. the battery) is connected in series with the power source controller (e.g. the DC-DC regulator). However, it is to be appreciated that the exemplary embodiments are not limited as such. The power source (e.g. the battery) may be separate from the power source controller (e.g. the DC-DC regulator). For example, the power source (e.g. the battery) may be connected directly to the first connector module and/or the second connector module.

In the described exemplary embodiments, the lighting element of the visual indicator member is described as a LED or LED light. It will be appreciated that the lighting element is not limited as such. For example, any form of lighting elements, such as e.g. incandescent light elements, photonic light elements etc., may be used as the lighting element of the visual indicator member. In addition, the control element of the visual indicator member is described as an activation on/off component. It will be appreciated that other forms of suitable control for the lighting element may be alternatively or additionally implemented. For example, a mechanical switch etc. may also be used.

It is to be appreciated that the mechanical transmitter mating member of the modular accessory device of the exemplary embodiments is not limited to the form described in the exemplary embodiments. For example, the mechanical transmitter mating member may be any other form of suitable connection so long as the modular accessory device may be securely mechanically coupled to the adjacent transmitter device.

It will be appreciated by a person skilled in the art that other variations and/or modifications may be made to the specific embodiments without departing from the scope of the claimed invention as broadly described. For example, in the description herein, features of different exemplary embodiments may be mixed, combined, interchanged, incorporated, adopted, modified, included etc. or the like across different exemplary embodiments. For example, exemplary embodiments are not necessarily mutually exclusive as some may be combined with one or more embodiments to form new exemplary embodiments. Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments. The present embodiments are, therefore, to be considered in all respects to be illustrative and not restrictive.

1. A modular accessory device comprising,
a first connector module for coupling to a first transmitter device, the first connector module comprising a first input member;
a power source controller coupled to the first connector module, the power source controller further arranged to be coupled to a power source;
a visual indicator member coupled to the first connector module;
wherein the first input member is arranged to receive a signal from the first transmitter device to instruct a first provision of power from the power source to the first transmitter device and a second provision of power to the visual indicator member; and further wherein the visual indicator member is arranged to be activated based on an indicator control signal received from the first transmitter device via the first input member.

2. The modular accessory device as claimed in claim 1, wherein the visual indicator member is disposed in the modular accessory device such that the visual indicator member is capable of being housed within an external actuation device.

3. The modular accessory device as claimed in claim 1, wherein the first connector module is disposed on a first side wall of the modular accessory device.

4. The modular accessory device as claimed in claim 1, wherein the first connector module further comprises a first output member for transmitting the first provision of power to the first transmitter device.

5. The modular accessory device as claimed in claim 1 further comprising,
a second connector module for coupling to a second transmitter device, the second connector module comprising a second input member;
the second connector module being coupled to the power source controller and to the visual indicator member;
wherein the second input member is arranged to receive a signal from the second transmitter device to instruct the first provision of power from the power source to the second transmitter device and the second provision of power to the visual indicator member; and further wherein the visual indicator member is arranged to be activated based on an indicator control signal received from the second transmitter device via the second input member.

6. The modular accessory device as claimed in claim 5, wherein the second connector module is disposed on a second side wall of the modular accessory device.

7. The modular accessory device as claimed in claim 5, wherein the second connector module further comprises a second output member for transmitting the first provision of power to the second transmitter device.

8. The modular accessory device as claimed in claim 1, further comprising a mechanical transmitter mating member disposed on a housing of the modular accessory device wherein the mechanical transmitter mating member is adapted to mechanically couple to at least one transmitter device.

9. The modular accessory device as claimed in claim 1, further comprising a mechanical actuator mating member disposed on a top surface of the modular accessory device wherein the mechanical actuator mating member is adapted to mechanically couple to at least one external actuator device.

10. A transmitter device for coupling to a modular accessory device as claimed in claim 1, the transmitter device comprising,
at least one electrically conductive member disposed on at least one side wall of the transmitter device, the at least one electrically conductive member arranged to allow electrical coupling to the first connector module;
a microcontroller module coupled to the at least one electrically conductive member;
a transceiver mechanism coupled to the microcontroller module;
wherein the microcontroller module is capable of transmitting a signal to the modular accessory device to instruct the first provision of power from the power source to the transmitter device; and
further wherein the microcontroller module is capable of transmitting an indicator control signal to the modular accessory device to activate the visual indicator member based on the transceiver mechanism.
